(19) United States
(12) Patent Application Publication
(10) Pub. No.: US 2014/0285540 A1
(43) Pub. Date: Sep. 25, 2014

(54) Method and LCD Control Circuit for Driving LCD

(71) Applicant: Dongguang Wu, Shenzhen (CN)

(72) Inventor: Dongguang Wu, Shenzhen (CN)

(73) Assignee: Shenzhen China Star Optoelectronics Technology Co., Ltd., Shenzhen, Guangdong (CN)

(21) Appl. No.: 14/008,591

(22) PCT Filed: Feb. 6, 2013
(86) PCT No.: PCT/CN13/71472

§ 371 Date: Sep. 30, 2013

(30) Foreign Application Priority Data
Feb. 5, 2013 (CN) 201310046373.8

(51) Int. Cl. G09G 3/36; G09G 3/34

(52) U.S. Cl. CPC G09G 3/36; G09G 3/3406; G09G 2310/0291; G09G 2310/08
USPC 345/691; 345/99; 345/102

(57) ABSTRACT

The present invention provides a driving method for an LCD and an LCD control circuit using the method thereof. The method includes three steps. Step 1 is that providing an LCD comprising an LCD panel and an LCD control circuit, including a display control unit, a timing controller and a microcontroller interface module, and an electrically erasable programmable read only memory (EEPROM) is integrated into the timing controller. Step 2 is to operate a backlight scan, the timing controller reads EEPROM parameter from the installed EEPROM to generate reference timing for keeping operation of the display control unit under control, and the display control unit generates VSYNC signals. Step 3 is that the control circuit drives the panel to display images. The timing controller in the method integrating the EEPROM simplifies circuit design and raises product integration to reduce producing costs.

### BACKGROUND OF THE INVENTION

1. Field of the Invention

The present invention relates to an electronic field technology, more particularly, to a method for driving a liquid crystal display (LCD) and an LCD control circuit using the method.

2. Description of the Prior Art

Technology is developing fast nowadays. Manufacturers design various information products to meet different demands for public. Most of displays in the past are cathode ray tube (CRT) monitors. Such displays have faults such as bulk, heavy power consumption, and radiation to harm users' health. Therefore, LCDs have been used gradually on the market in place of traditional CRT displays.

An LCD with various advantages like slimness, energy-saving, non-radiation, etc, has been applied broadly. Most of LCDs on the market are backlight type LCD comprising an LCD panel and a backlight module. The working principle of an LCD panel is that an alignment of liquid crystal molecules between two parallel glass substrates is controlled by applying voltage, refracting light from the backlight module to generate images. Since the

LCD panel does not emit light, using the backlight module to emit light is necessary to display images. Therefore, the backlight module is one of the key components of the LCD device. Furthermore, it controls light transmittance of a backlight module by changing rotation of liquid crystal molecules to adjust brightness of the panel. The part of an operating circuit having various timing controls for driving an LCD panel is called timing controller (TCON) and understood as a timing control circuit.

Extended display identification data (EDID) and electrically erasable programmable read only memory (EEPROM) data are respectively restored in two integrated circuit (IC) chips with storage capacities of 2 k and 16 k. The system reads EDID in one IC chip, and the timing controller reads EEPROM parameters in the other IC chip after the system enables.

Conventionally, the EEPROM is an independent chip, and the timing controller has to read the EEPROM parameter from the other IC chip. In hence, it is difficult to meet the miniaturization demand for devices in the present on account of complicated circuit structure and cost.

### SUMMARY OF THE INVENTION

An object of the present invention is to provide a method for driving an LCD, and an EEPROM is integrated within a timing controller to simplify circuit design and to reduce costs.

Another object of the present invention is to provide an LCD control circuit to simplify circuit design, to raise product integration and to reduce producing costs to raise market competition.

According to the present invention, a method for driving an LCD comprises the following steps:

Step 1: providing an LCD comprising an LCD panel and an LCD control circuit electrically connected with the LCD panel, the LCD control circuit comprising a display control unit, a timing controller electrically connected with the display control unit and a microcontroller interface module electrically connected with the display control unit, and an electrically erasable programmable read only memory (EEPROM) being integrated within the timing controller;

Step 2: operating a backlight scan, the timing controller reading EEPROM parameters from the EEPROM to generate reference timing for keeping operation of the display control unit under control, and the display control unit generating VSYNC signals;

Step 3: the LCD control circuit driving the LCD panel to display images according to the VSYNC signals from the display control unit, the reference timing from the timing controller and displayed data and commands received from the microcontroller interface module.

Furthermore, the LCD control circuit further comprises an LCD panel interface module electrically connected with the display control unit, and the display control unit receives data and commands via the microcontroller interface module and drives the LCD panel through the LCD panel interface module.

Furthermore, the LCD control circuit further comprises a display storage unit electrically connected with the display control unit.

Furthermore, EEPROM parameter is pre-stored in the EEPROM, the timing controller generates reference timing according to the EEPROM parameter.

Furthermore, Step 1 further comprises to provide a main board system end electrically connected with the microcontroller interface module, Step 2 further comprises that the main board system end switches between a 2D mode and a 3D mode by providing 3D_EN signals to the display control unit via the microcontroller interface module when operating a backlight scan.

According to the present invention, a method for driving an LCD comprises the following steps:

Step 1: providing an LCD comprising an LCD panel and an LCD control circuit electrically connected with the LCD panel, the LCD control circuit comprising a display control unit, a timing controller electrically connected with the display control unit and a microcontroller interface module electrically connected with the display control unit, and an electrically erasable programmable read only memory (EEPROM) being integrated within the timing controller;

Step 2: operating a backlight scan, the timing controller reading EEPROM parameters from the EEPROM to generate reference timing for keeping operation of the display control unit under control, and the display control unit generating VSYNC signals;

Step 3: the LCD control circuit driving the LCD panel to display images according to the VSYNC signals from the display control unit, the reference timing from the timing controller and displayed data and commands received from the microcontroller interface module,

wherein the LCD control circuit further comprises an LCD panel interface module electrically connected with the display control unit, and the display control unit receives data and commands via the microcontroller interface module and drives the LCD panel through the LCD panel interface module,

wherein the LCD control circuit further comprises a display storage unit electrically connected with the display control unit,

wherein EEPROM parameter is pre-stored in the EEPROM, the timing controller generates reference timing according to the EEPROM parameter,

wherein Step 1 further comprises to provide a main board system end electrically connected with the microcontroller interface module, Step 2 further comprises that the main board system end switches between a 2D mode and a 3D mode by providing 3D_EN signals to the display control unit via the microcontroller interface module when operating a backlight scan.

According to present invention, an LCD control circuit comprises a display control unit, a timing controller electrically connected with the display control unit and a microcontroller interface module electrically connected with the display control unit. An EEPROM is integrated within the timing controller.

Furthermore, the timing controller reads EEPROM parameters from the EEPROM to generate reference timing for keeping operation of the display control unit, and the display control unit generates VSYNC signals.

Furthermore, a main board system end electrically connected to the microcontroller interface module is used for supplying the 3D_EN signals to the display control unit via the microcontroller interface module to perform a switch between 2D mode and a 3D mode.

Furthermore, the LCD control circuit further comprises an LCD panel interface module electrically connected with the display control unit. The display control unit receives data and commands via the microcontroller interface module and drives an LCD panel through the LCD panel interface module.

Furthermore, the LCD control circuit further comprises a display storage unit electrically connected with the display control unit.

A benefit of the present invention is that the method for driving the LCD uses the timing controller integrating the EEPROM and uses a display control unit to generate vertical synchronous (VSYNC) signals, and a main board system end generates 3D_EN signals so that it simplifies circuit design and saves product costs. The LCD control circuit according to the present invention capable of simplifying circuit design, integrating more circuit and saving producing costs miniaturizes the products to raise market competition.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification.

FIG. 1 illustrates a flowchart of a method for driving a liquid crystal display according to a preferred embodiment of the present invention.

FIG. 2 illustrates a block diagram of a liquid crystal display according to a preferred embodiment of the present invention.

FIG. 3 illustrates a block diagram of a LCD control circuit according to a preferred embodiment of the present invention.

### DETAILED DESCRIPTION OF THE PREFERRED EMBODIMENTS

The drawings illustrate embodiments of the invention and, together with the description, serve to explain the principles of the invention.

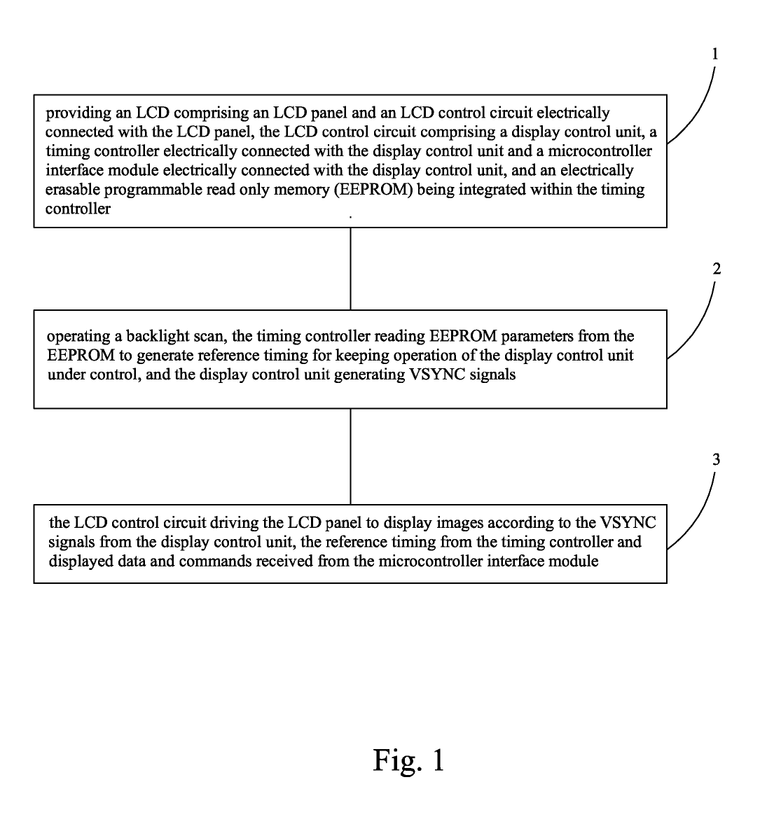

Please refer to FIG. 1 to FIG. 3, the present invention provides a method for driving an LCD comprising the following steps:

Step 1: Provide an LCD 20 comprising an LCD panel 24 and an LCD control circuit 22 electrically connected with the LCD panel 24. The LCD control circuit 22 comprises a display control unit 32, a timing controller 34 electrically connected with the display control unit 32 and a microcontroller (MCU) interface module 38 electrically connected with the display control unit 32. An EEPROM 342 is integrated within the timing controller 34.

A main board system end (not shown) electrically connected with the MCU interface module 38 is provided so that the main board system end transmits control signals to the display control unit 32 through the MCU interface module 38.

EEPROM parameters are pre-stored in the EEPROM 342. The timing controller 34 generates reference timing according to the EEPROM parameters, and the display control unit 32 drives the LCD panel 24 based on the reference timing.

The LCD control circuit 22 further comprises a display storage unit 39 and an LCD panel interface module 36, and both are electrically connected with the display control unit 32. The display control unit 32 in control of the timing controller 34 receives data and commands via the MCU interface module 38. The display storage unit 39 and correspondent units store and operate according to the data and commands. The LCD control circuit 22 drives the LCD panel 24 to show images.

Step 2: Perform a backlight scan. The timing controller 34 reads the EEPROM parameters from the EEPROM 342 to generate the reference timing keeping operation of the display control unit 32 under control, and the display control unit 32 generates vertical synchronous (VSYNC) signals.

In the preferred embodiment, the step further comprises that the main board system end provides 3D_EN signals to the display control unit 32 via the MCU interface module 38 and then controls the LCD 20 to switch between a 2D mode and a 3D mode when operating the backlight scan.

During a backlight scan, in contrast to generating VSYNC signals and 3D_EN signals by CB in the prior art, the present invention proposes that the VSYNC signals are generated from the display control unit 32 and the 3D_EN signals are generated from the main board system end to the display control unit 32 via the MCU interface module 38. Therefore, the LCD panel 24 is normally driven even if the EEPROM 342 is integrated within the timing controller 34.

Step 3: the LCD control circuit 22 drives the LCD panel 24 to display images according to the VSYNC signals from the display control unit 32, the reference timing from the timing controller 34 and the displayed data and commands received from the MCU interface module 38

In the present invention, the LCD switches display modes between a 2D or 3D mode according to the 3D_EN signals from the main board system end. Whatever 2D or 3D mode it is, the LCD control circuit 22 always drives the LCD panel 24 to display images according to the VSYNC signals from the display control unit 32, the reference timing from the timing controller 34 and the displayed data and commands received from the MCU interface module 38

The method for driving the LCD according to the present invention simplifies circuit design and saves producing costs by integrating the EEPROM 342 into the timing controller 34 and using the display control unit 32 to generate VSYNC signals and using the system end to generate 3D_EN signals to the display control unit 32 via the MCU interface module 38.

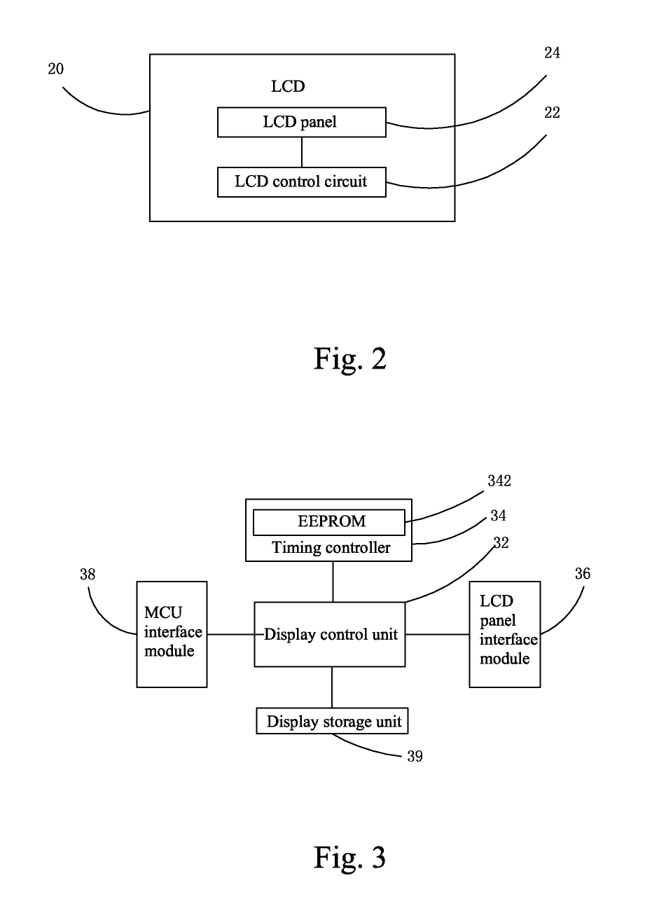

Refer to FIG. 2 and FIG. 3, the present invention further provides an LCD control circuit comprising the display control unit 32, the timing controller 34 electrically connected with the display control unit 32 and the MCU interface module 38 electrically connected with the display control unit 32. An EEPROM 342 is integrated within the timing controller 34. The LCD control circuit according to the present invention integrating the EEPROM 342 into the timing controller 34 simplifies circuit design, raises product integration and reduces producing costs to miniaturize products to raise market competition.

EEPROM parameters are pre-stored in the EEPROM 342, the timing controller 34 generates reference timing according to the EEPROM parameter pre-stored in the EEPROM 342, and the display control unit 32 drives the LCD panel 24 based on the reference timing.

The LCD control circuit 22 further comprises a display storage unit 39 and the LCD panel interface module 36, both the monitor storage unit 39 and the LCD panel interface module 36 are electrically connected to the display control unit 32. The display control unit 32 in control of the timing controller 34 receives data and commands via the MCU interface module 38. The display storage unit 39 and correspondent units store and operate according to the data and commands. The LCD control circuit 22 drives the LCD panel 24 to show images.

The MCU interface module 38 is further electrically connected with a main board system end (not shown), and the main board system end provides 3D_EN signals to the display control unit 32 via the MCU interface module 38 to control the LCD to switch between the 2D mode and the 3D mode.

During a backlight scan, in contrast to generating VSYNC signals and 3D_EN signals by CB in the prior art, the present invention proposes that the VSYNC signals are generated from the display control unit 32 and the 3D_EN signals are generated from the main board system end to the display control unit 32 via the MCU interface module 38. Therefore, the LCD panel 24 is normally driven even if the EEPROM 342 is integrated within the timing controller 34.

In sum, the present invention provides the method for driving the LCD integrating the EEPROM into the timing controller and using the display control unit to generate VSYNC signals, and the main board system end generates 3D_EN signals so that it simplifies circuit design and saves producing costs. The present invention further provides the LCD control circuit capable of simplifying circuit design, integrating more circuit and saving producing costs to miniaturize the products to boost market competition.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for driving an LCD comprising the following steps:
Step 1: providing an LCD comprising an LCD panel and an LCD control circuit electrically connected with the LCD panel, the LCD control circuit comprising a display control unit, a timing controller electrically connected with the display control unit and a microcontroller interface module electrically connected with the display control unit, and an electrically erasable programmable read only memory (EEPROM) being integrated within the timing controller;
Step 2: operating a backlight scan, the timing controller reading EEPROM parameters from the EEPROM to generate reference timing for keeping operation of the display control unit under control, and the display control unit generating VSYNC signals;
Step 3: the LCD control circuit driving the LCD panel to display images according to the VSYNC signals from the display control unit, the reference timing from the timing controller and displayed data and commands received from the microcontroller interface module.

2. The method for driving the LCD of claim 1, wherein the LCD control circuit further comprises an LCD panel interface module electrically connected with the display control unit, and the display control unit receives data and commands via the microcontroller interface module and drives the LCD panel through the LCD panel interface module.

3. The method for driving the LCD of claim 2, wherein the LCD control circuit further comprises a display storage unit electrically connected with the display control unit.

4. The method for driving the LCD of claim 1, wherein the EEPROM parameters are pre-stored in the EEPROM, the timing controller generates reference timing according to the EEPROM parameter.

5. The method for driving the LCD of claim 1, wherein Step 1 further comprises to provide a main board system end electrically connected with the microcontroller interface module, Step 2 further comprises that the main board system end switches between a 2D mode and a 3D mode by providing 3D_EN signals to the display control unit via the microcontroller interface module when operating a backlight scan.

6. A method for driving an LCD comprising the following steps:
Step 1: providing an LCD comprising an LCD panel and an LCD control circuit electrically connected with the LCD panel, the LCD control circuit comprising a display control unit, a timing controller electrically connected with the display control unit and a microcontroller interface module electrically connected with the display control unit, and an electrically erasable programmable read only memory (EEPROM) being integrated within the timing controller;
Step 2: operating a backlight scan, the timing controller reading EEPROM parameters from the EEPROM to generate reference timing for keeping operation of the display control unit under control, and the display control unit generating VSYNC signals;
Step 3: the LCD control circuit driving the LCD panel to display images according to the VSYNC signals from the display control unit, the reference timing from the timing controller and displayed data and commands received from the microcontroller interface module,
wherein the LCD control circuit further comprises an LCD panel interface module electrically connected with the display control unit, and the display control unit receives data and commands via the microcontroller interface module and drives the LCD panel through the LCD panel interface module,
wherein the LCD control circuit further comprises a display storage unit electrically connected with the display control unit,
wherein EEPROM parameter is pre-stored in the EEPROM, the timing controller generates reference timing according to the EEPROM parameter,
wherein Step 1 further comprises to provide a main board system end electrically connected with the microcontroller interface module, Step 2 further comprises that the main board system end switches between a 2D mode and a 3D mode by providing 3D_EN signals to the display control unit via the microcontroller interface module when operating a backlight scan.

7. An LCD control circuit comprising a display control unit, a timing controller electrically connected with the display control unit and a microcontroller interface module electrically connected with the display control unit, and an EEPROM is integrated within the timing controller.

8. The LCD control circuit of claim 7, wherein the timing controller reads EEPROM parameters from the EEPROM to generate reference timing for keeping operation of the display control unit, and the display control unit generates VSYNC signals.

9. The LCD control circuit of claim 8, wherein a main board system end electrically connected to the microcontroller interface module is used for supplying the 3D_EN signals to the display control unit via the microcontroller interface module to perform a switch between 2D mode and a 3D mode.

10. The LCD control circuit of claim 7, further comprising an LCD panel interface module electrically connected with the display control unit, wherein the display control unit receives data and commands via the microcontroller interface module and drives an LCD panel through the LCD panel interface module.

11. The LCD control circuit of claim 10 further comprising a display storage unit electrically connected with the display control unit.
